(19) United States
(12) Patent Application Publication
(10) Pub. No.: US 2022/0395749 A1
(43) Pub. Date: Dec. 15, 2022

(54) METHOD AND APPARATUS FOR GAME LIVE STREAM INTERACTION, ELECTRONIC DEVICE AND STORAGE MEDIUM

(71) Applicant: Beijing Dajia Internet Information Technology Co., Ltd., Beijing (CN)

(72) Inventor: Lei HAN, Beijing (CN)

(21) Appl. No.: 17/576,556

(22) Filed: Jan. 14, 2022

(30) Foreign Application Priority Data
Jun. 15, 2021 (CN) 202110660371.2

(51) Int. Cl. A63F 13/355; H04N 21/2187; H04N 21/472; H04N 21/437; H04N 21/488; H04N 21/475; A63F 13/86

(52) U.S. Cl. CPC A63F 13/355; H04N 21/2187; H04N 21/472; H04N 21/437; H04N 21/4882; H04N 21/4758; A63F 13/86; A63F 2300/577; A63F 2300/538

(57) ABSTRACT

A method and apparatus for game live stream interaction, an electronic device and a storage medium are disclosed. The method includes: displaying a live video resource and an interactive control corresponding to the live video resource, where the interactive control is configured to enable an audience end to select a virtual prop in a game live stream, and a selection range of virtual props at the audience end is identical to a selection range of virtual props at a corresponding live streamer end; determining prop selection information of the audience end in response to a triggering operation of the audience end on the interactive control; sending an interaction request to a live stream server, where the interaction request comprises the prop selection information of the audience end; and displaying interaction response information sent by the live stream server.

### CROSS REFERENCE TO RELATED APPLICATIONS

This application claims priority to Chinese Patent Application No. 202110660371.2, filed on Jun. 15, 2021, in the China National Intellectual Property Administration, the disclosure of which is herein incorporated by reference in its entirety.

### FIELD

The present disclosure relates to the field of Internet technology, and particularly to a method and apparatus for game live stream interaction, an electronic device and a storage medium.

### BACKGROUND

With the rapid development of Internet technology, there are more and more types of live streams, such as a game live stream, a party live stream, etc.

The users at the audience end are supported to participate in live stream interactions in related technologies, for example, the users at the audience end are allowed to post bullet screen comments during the live stream, give gifts to live streamer or anchor at the live streamer end, etc. The live streamer or anchor is a person who broadcasts himself/herself online through a live stream.

### SUMMARY

Embodiments of the present disclosure provide a method and apparatus for game live stream interaction, an electronic device and a storage medium.

In an aspect of the present disclosure, a method for game live stream interaction is provided, the method including: displaying a live video resource and an interactive control corresponding to the live video resource, where the interactive control is configured to enable an audience end to select a virtual prop in a game live stream, and a selection range of virtual props at the audience end is identical to a selection range of virtual props at a corresponding live streamer end; determining prop selection information of the audience end in response to a triggering operation of the audience end on the interactive control; sending an interaction request to a live stream server, where the interaction request includes the prop selection information of the audience end; displaying interaction response information sent by the live stream server, where the interaction response information is determined by the live stream server according to the prop selection information of the audience end and prop selection information of the live streamer end.

In some possible embodiments, in a case that an account corresponding to the audience end is not contained in an account set corresponding to the live streamer end, the interaction request is a guess request for guessing the prop selection information of the live streamer end.

In some possible embodiments, in a case that an account corresponding to the audience end is contained in an account set corresponding to the live streamer end, the interaction request is a recommendation request for recommending prop selection information to the live streamer end.

In some possible embodiments, the account corresponding to the audience end is added to the account set corresponding to the live streamer end by: displaying a recommendation entrance to the audience end in response to determining that the audience end meets a preset prop recommendation condition; sending an addition application to the live stream server in response to a preset operation of the audience end on the recommendation entrance, where the addition application is used to request to add the account corresponding to the audience end to the account set corresponding to the live streamer end; displaying a successful addition message sent by the live stream server.

In some possible embodiments, the interaction response information includes a task completion status of the audience end and/or an electronic resource obtained, and the method further includes: displaying the task completion status of the audience end and/or the electronic resource obtained in response to a display operation of the audience end on the interaction response information.

In some possible embodiments, the method further includes: displaying prop selection information of other audience ends in a corresponding live stream room sent by the live stream server.

In some possible embodiments, a voting entrance for the prop selection information of other audience ends is also displayed, and the method further includes: determining a voting result of the audience end in response to a voting operation of the audience end on the voting entrance; sending the voting result of the audience end to the live stream server.

In some possible embodiments, the method further includes: displaying voting results of other audience ends and/or voting statistics information of various prop selections sent by the live stream server.

In some possible embodiments, the method further includes: prompting a preset prop selection rule to the audience end to assist the audience end in prop selection in response to receiving prompt information sent by the live stream server, where the prompt information is used to prompt that the prop selection of the audience end does not conform to the preset prop selection rule.

In some possible embodiments, the method further includes: timing prop operation time of the audience end; determining that the audience end abandons a current prop selection operation in response to determining that the prop selection information of the audience end is not determined when the prop operation time exceeds set time.

In another aspect of the present disclosure, a method for game live stream interaction is provided, the method including: receiving an interaction request sent from an audience end, where the interaction request includes prop selection information of the audience end, the prop selection information is determined based on a trigger operation of the audience end on an interactive control, the interactive control corresponds to a live video resource, the interactive control is configured to enable the audience end to select a virtual prop in a game live stream, and a selection range of virtual props at the audience end is identical to a selection range of virtual props at a corresponding live streamer end; determining interaction response information according to the prop selection information of the audience end and prop selection information of the live streamer end; sending the interaction response information to the audience end.

In some possible embodiments, the interaction request is a recommendation request for recommending prop selection information to the live streamer end, and the method further includes: sending the prop selection information of the audience end to the live streamer end to assist the live streamer end in selecting a virtual prop.

In some possible embodiments, the method further includes: receiving an addition application sent by the audience end, where the addition application is used to request to add an account corresponding to the audience end to an account set corresponding to the live streamer end; adding the account corresponding to the audience end to the account set corresponding to the live streamer end in response to determining that a preset addition rule is satisfied, and sending a successful addition message to the audience end.

In some possible embodiments, determining the interaction response information according to the prop selection information of the audience end and the prop selection information of the live streamer end, includes: comparing the prop selection information of the audience end with the prop selection information of the live streamer end to obtain a comparison result; determining a task completion status of the audience end according to a preset task corresponding to the interaction request and the comparison result; determining an electronic resource obtained by the audience end based on the task completion status of the audience end; determining the task completion status of the audience end and/or the electronic resource obtained as the interaction response information.

In some possible embodiments, the method further includes: sending prop selection information of other audience ends in a corresponding live stream room to the audience end for display by the audience end.

In some possible embodiments, the audience end also displays a voting entrance for the prop selection information of other audience ends, and the method further includes: receiving a voting result sent by the audience end, where the voting result is obtained by the audience end performing a voting operation based on the voting entrance; performing voting statistics on a corresponding prop selection based on the voting result.

In some possible embodiments, the method further includes: sending voting results of other audience ends and/or voting statistics information of various prop selections to the audience end for display by the audience end.

In some possible embodiments, the method further includes: sending prompt information to the audience end in response to determining that prop selection of the audience end does not conform to a preset prop selection rule according to the prop selection information of the audience end, where the prompt information is used to prompt that the prop selection of the audience end does not conform to the preset prop selection rule.

In some possible embodiments, in a case that the live streamer end selects a virtual prop actively, the prop selection information of the live streamer end is obtained from a game server; in a case that the live streamer end selects a virtual prop passively, various prop selections are sorted based on prop selection information currently received, and the prop selection information of the live streamer end is determined based on a sorting result.

In another aspect of the present disclosure, an apparatus for game live stream interaction is provided, the apparatus including: a first display unit configured to display a live video resource and an interactive control corresponding to the live video resource, where the interactive control is configured to enable an audience end to select a virtual prop in a game live stream, and a selection range of virtual props at the audience end is identical to a selection range of virtual props at a corresponding live streamer end; a determining unit configured to determine prop selection information of the audience end in response to a triggering operation of the audience end on the interactive control; a sending unit configured to send an interaction request to a live stream server, where the interaction request includes the prop selection information of the audience end; a second display unit configured to display interaction response information sent by the live stream server, where the interaction response information is determined by the live stream server according to the prop selection information of the audience end and prop selection information of the live streamer end.

In some possible embodiments, in a case that an account corresponding to the audience end is not contained in an account set corresponding to the live streamer end, the interaction request is a guess request for guessing the prop selection information of the live streamer end.

In some possible embodiments, in a case that an account corresponding to the audience end is contained in an account set corresponding to the live streamer end, the interaction request is a recommendation request for recommending prop selection information to the live streamer end.

In some possible embodiments, the apparatus further includes an addition unit configured to add the account corresponding to the audience end to the account set corresponding to the live streamer end by: displaying a recommendation entrance to the audience end in response to determining that the audience end meets a preset prop recommendation condition; sending an addition application to the live stream server in response to a preset operation of the audience end on the recommendation entrance, where the addition application is used to request to add the account corresponding to the audience end to the account set corresponding to the live streamer end; displaying a successful addition message sent by the live stream server.

In some possible embodiments, the interaction response information includes a task completion status of the audience end and/or an electronic resource obtained, the second display unit is further configured to display the task completion status of the audience end and/or the electronic resource obtained in response to a display operation of the audience end on the interaction response information.

In some possible embodiments, the second display unit is further configured to receive prop selection information of other audience ends in a corresponding live stream room sent by the live stream server.

In some possible embodiments, the second display unit is further configured to display a voting entrance for the prop selection information of other audience ends; the determining unit is further configured to determine a voting result of the audience end in response to a voting operation of the audience end on the voting entrance; the sending unit is further configured to send the voting result of the audience end to the live stream server.

In some possible embodiments, the second display unit is further configured to display voting results of other audience ends and/or voting statistics information of various prop selections sent by the live stream server.

In some possible embodiments, the apparatus further includes: a prompting unit configured to prompt a preset prop selection rule to the audience end to assist the audience end in prop selection in response to receiving prompt information sent by the live stream server, where the prompt information is used to prompt that prop selection of the audience end does not conform to the preset prop selection rule.

In some possible embodiments, the apparatus further includes: a timing unit configured to time prop operation time of the audience end; and determine that the audience end abandons a current prop selection operation in response to determining that the prop selection information of the audience end is not determined when the prop operation time exceeds set time.

In another aspect of the present disclosure, an apparatus for game live stream interaction is provided, the apparatus including: a receiving unit configured to receive an interaction request sent from an audience end, where the interaction request includes prop selection information of the audience end, the prop selection information is determined based on a trigger operation of the audience end on an interactive control, the interactive control corresponds to a live video resource, the interactive control is configured to enable the audience end to select a virtual prop in a game live stream, and a selection range of virtual props at the audience end is identical to a selection range of virtual props at a corresponding live streamer end; a determining unit configured to determine interaction response information according to the prop selection information of the audience end and prop selection information of the live streamer end; a sending unit configured to send the interaction response information to the audience end.

In some possible embodiments, the interaction request is a recommendation request for recommending prop selection information to the live streamer end, and the sending unit is further configured to send the prop selection information of the audience end to the live streamer end to assist the live streamer end in selecting a virtual prop.

In some possible embodiments, the apparatus further includes an addition unit, the receiving unit is further configured to receive an addition application sent by the audience end, where the addition application is used to request to add an account corresponding to the audience end to an account set corresponding to the live streamer end; the addition unit is configured to add the account corresponding to the audience end to the account set corresponding to the live streamer end in response to determining that a preset addition rule is satisfied, and send a successful addition message to the audience end.

In some possible embodiments, the determining unit is specifically configured to: compare the prop selection information of the audience end with the prop selection information of the live streamer end to obtain a comparison result; determine a task completion status of the audience end according to a preset task corresponding to the interaction request and the comparison result determine an electronic resource obtained by the audience end based on the task completion status of the audience end; determine the task completion status of the audience end and/or the electronic resource obtained as the interaction response information.

In some possible embodiments, the sending unit is further configured to send prop selection information of other audience ends in a corresponding live stream room to the audience end for display by the audience end.

In some possible embodiments, the audience end also displays a voting entrance for the prop selection information of other audience ends, and the apparatus further includes a statistics unit, the receiving unit is further configured to receive a voting result sent by the audience end, where the voting result is obtained by the audience end performing a voting operation based on the voting entrance the statistics unit is configured to perform voting statistics on a corresponding prop selection based on the voting result.

In some possible embodiments, the sending unit is further configured to send voting results of other audience ends and/or voting statistics information of various prop selections to the audience end for display by the audience end.

In some possible embodiments, the apparatus further includes: a prompting unit configured to send prompt information to the audience end in response to determining that prop selection of the audience end does not conform to a preset prop selection rule according to the prop selection information of the audience end, where the prompt information is used to prompt that the prop selection of the audience end does not conform to the preset prop selection rule.

In some possible embodiments, the determining unit is configured to: obtain prop selection information of the live streamer end from a game server in response to determining that the live streamer end selects a virtual prop actively; sort various prop selections based on prop selection information currently received and determine the prop selection information of the live streamer end based on a sorting result in response to determining that the live streamer end selects a virtual prop passively.

In another aspect of the present disclosure, a system for game live stream interaction is provided, including: an audience end configured to display a live video resource and an interactive control corresponding to the live video resource, where the interactive control is configured to enable an audience end to select a virtual prop in a game live stream, and a selection range of virtual props at the audience end is identical to a selection range of virtual props at a corresponding live streamer end; determine prop selection information of the audience end in response to a triggering operation of the audience end on the interactive control; send an interaction request to a live stream server, where the interaction request includes the prop selection information of the audience end; and display interaction response information sent by the live stream server; a live stream server configured to receive the interaction request sent by the audience end, determine the interaction response information according to prop selection information of the live streamer end and the prop selection information of the audience end included in the interaction request, and send the interaction response information to the audience end.

In another aspect of the present disclosure, an electronic device for game live stream interaction is provided, including: a processor; a memory for storing instructions executable by the processor; where the processor is configured to execute the instructions to implement any, method for game live stream interaction described above.

In another aspect of the present disclosure, a storage medium is provided, where instructions in the storage medium, when executed by a processor of an electronic device for live stream interaction, enable the electronic device for live stream interaction to perform any method for game live stream interaction described above.

In another aspect of the present disclosure, a computer program product is provided, the computer program product including a computer program which implements any method for game live stream interaction described above when executed by a processor.

Solutions of the present disclosure at least bring following beneficial effects.

In embodiments of the present disclosure, the live video resource and the interactive control corresponding to the live video resource are displayed, where the interactive control is configured to enable the audience end to select the virtual prop in the game live stream, and the selection range of virtual props at the audience end is identical to the selection range of virtual props on the corresponding live streamer end; the prop selection information of the audience end is determined in response to the triggering operation of the audience end on the interactive control; the interaction request is sent to the live stream server, where the interaction request includes the prop selection information of the audience end; and the interaction response information sent by the live stream server is displayed, where the interaction response information is determined by the live stream server according to the prop selection information of the audience end and the prop selection information of the live streamer end. In this way, users at the audience end no longer act as the audiences of the game live stream but can participate in the game live stream process at the live stream side, and the sense of presence and participation of the users can be improved, so the retention rate of users can be improved.

### BRIEF DESCRIPTION OF THE DRAWINGS

The accompanying drawings here are incorporated into and constitute a part of the specification, illustrate embodiments conforming to the present disclosure; and together with the specification, serve to explain principles of the disclosure, but not constitute an improper limitation on the disclosure.

FIG. 1 is an application scenario diagram of a method for game live stream interaction according to an embodiment of the present disclosure;

FIG. 2 is a schematic flowchart of a method for game live stream interaction according to an embodiment of the present disclosure;

FIG. 3 is a schematic diagram of a page when a live streamer starts a game live stream according to an embodiment of the present disclosure;

FIG. 4 is a schematic diagram of a guess page of Fight the Landlord according to an embodiment of the present disclosure;

FIG. 5 is a schematic diagram of a page of a guess task according to an embodiment of the present disclosure;

FIG. 6 is a schematic diagram of a page of guess ranking according to an embodiment of the present disclosure;

FIG. 7 is a schematic diagram of a page of a think tank task according to an embodiment of the present disclosure;

FIG. 8 is a schematic diagram of a recommendation page according to an embodiment of the present disclosure;

FIG. 9 is a schematic diagram of a think tank management page according to an embodiment of the present disclosure;

FIG. 10 is a schematic diagram of a settlement page of a think tank task according to an embodiment of the present disclosure;

FIG. 11 is a flowchart of a method for game live stream interaction according to an embodiment of the present disclosure;

FIG. 12 is a flowchart of another method for game live stream interaction according to an embodiment of the present disclosure;

FIG. 13 is a flowchart of another method for game live stream interaction according to an embodiment of the present disclosure;

FIG. 14 is a flowchart of another method for game live stream interaction according to an embodiment of the present disclosure;

FIG. 15 is a block diagram of an apparatus for game live stream interaction according to an embodiment of the present disclosure;

FIG. 16 is a block diagram of another apparatus for game live stream interaction according to an embodiment of the present disclosure;

FIG. 17 is a structural schematic diagram of an electronic device for game live stream interaction according to an embodiment of the present disclosure.

### DETAILED DESCRIPTION OF EMBODIMENTS

In order to enable those ordinary skilled in the art to better understand technical solutions of the disclosure, the technical solutions in embodiments of the present disclosure will be described clearly and completely with reference to the accompanying drawings.

It should be noted that terms such as “first”, “second” and the like in the specification and claims of the present disclosure and the above drawings are used to distinguish similar objects, but not necessarily to describe a particular order or sequence. It should be understood that the data used in this way is interchangeable under appropriate circumstances, so that embodiments of the present disclosure described herein can be implemented in an order other than those illustrated or described herein.

In order to facilitate those skilled in the art to better understand the technical solutions of the present disclosure, the technical terms involved in the present disclosure will be described below.

Virtual prop refers to an object in a game, and virtual props in different games are generally different, for example, the virtual props in the Fight the Landlord game are virtual playing cards, and the virtual props in the chess game are virtual chess.

Electronic resource refers to a reward obtained from playing a game, such as an electronic red envelope, a gold coin, a gold shell, etc.

Prop selection information refers to whether a virtual prop is selected, which virtual prop is selected, and other information. The game playing method of a corresponding person can be known according to the prop selection information.

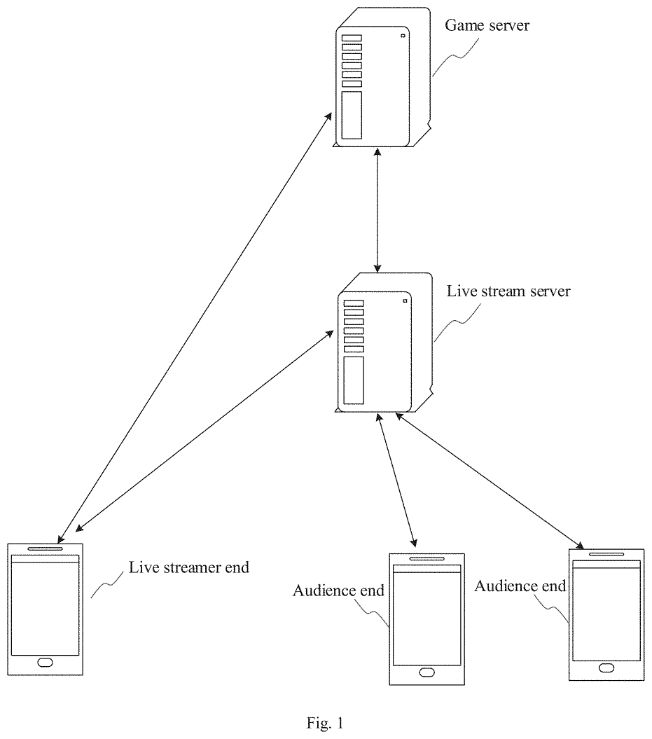

FIG. 1 is an application scenario diagram of a method for game live stream interaction according to an embodiment, including a live streamer end, a live stream server, a game server and an audience end.

The live streamer end may install a live stream application. A live streamer at the live streamer end opens the live stream application, selects a game and interaction live room, and then can see a variety of games that can be interactively streamed. After clicking any game, the live streamer end may obtain a game resource from the game server corresponding to the game. Then the live streamer may start playing the game, enable a screen recording tool to record the screen, and then send the live video resource obtained by screen recording to the live stream server.

The live stream server receives the live video resource sent by the live streamer end, generates a control resource corresponding to the live video resource, and sends the live video resource and the control resource to each audience end entering the corresponding live stream room.

Each audience end may install a client to watch a video, receives the live video resource and the control resource sent by the live stream server through the client, displays the live video resource, and displays an interactive control corresponding to the live video resource based on the control resource. The interactive control is configured to enable the audience end to select a virtual prop in a game live stream, and a selection range of virtual props at the audience end is identical to a selection range of virtual props at a corresponding live streamer end. Then, prop selection information of the audience end may be determined in response to a triggering operation of the interactive control at the audience end, and the prop selection information is carried in an interaction request and sent to the live stream server.

The live stream server receives the interaction request sent by any audience end, determines interaction response information corresponding to the audience end according to prop selection information of the live streamer end and the prop selection information of the audience end after determining the prop selection information of the live streamer end, and sends the interaction response information to the audience end, where the interaction response information is used to represent whether the prop selection at the live streamer end matches with the prop selection at the audience end.

The corresponding audience end displays the interaction response information sent by the live stream server.

In this way, the user at the audience end can participate in the game live stream of the live streamer while watching the game live stream, instead of just being a viewer of the live video. The sense of presence and participation of the user is improved, so the retention rate of user can be improved.

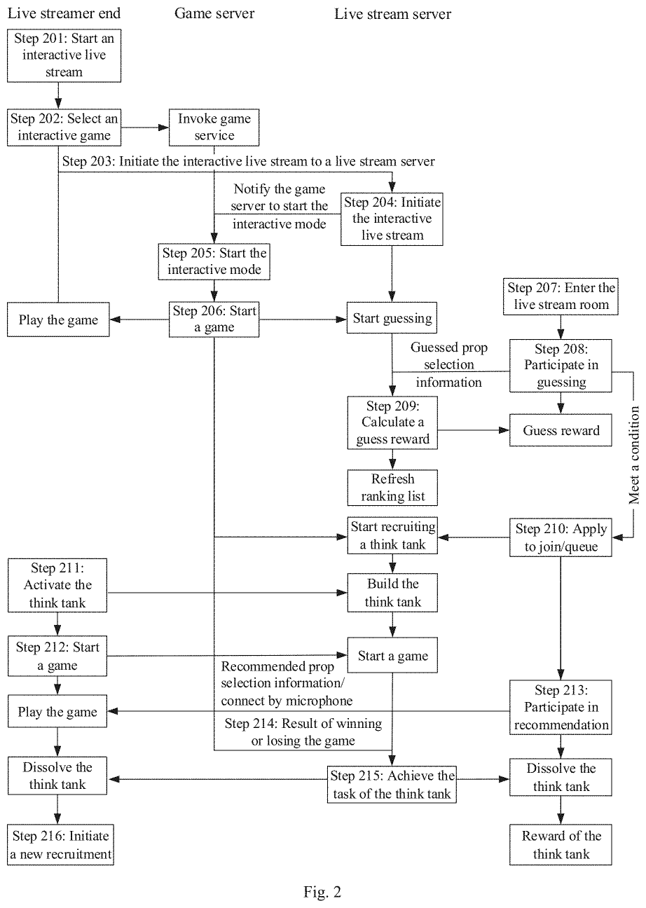

FIG. 2 is a schematic flowchart of a method for game live stream interaction according to an embodiment, including following steps.

Step 201: a live streamer end starts an interactive live stream.

Step 202: the live streamer end selects an interactive game, and invokes the corresponding interactive game from a corresponding game server.

Step 203: the live streamer end initiates the interactive live stream to a live stream server.

Step 204: the live stream server initiates the interactive live stream, and notifies the game server to start the interactive mode.

Step 205: the game server starts the interactive mode.

Step 206: the game server starts a game, and the live streamer end starts to play the game and informs the live stream server to start guessing and start recruiting a think tank.

Here, accounts corresponding to audiences who join the think tank constitute an account set corresponding to the live streamer end.

Step 207: an audience end enters the live stream room.

Step 208: the audience end participates in guessing and sends the guessed prop selection information to the live stream server.

Step 209: the live stream server calculates a guess reward according to the prop selection information of the live streamer end and the prop selection information of the audience end, refreshes guess ranking, and sends the guess reward to the audience end.

Here, a guess result is used to indicate whether the audience end guessed the prop selection at the live streamer end correctly. In a specific implementation, the live stream server may determine a completion status of a guess task of the audience end according to the guess result of the audience end, calculate the guess reward based on the completion status of the guess task, refresh the guess ranking, and send the guess reward to the audience end. Here, the guess reward may be all forms of electronic resources, such as an electronic red envelope, a gold coin, a gold shell, etc.

Step 210: the audience end applies to join/queue for the think tank activated by the live streamer end in response to determining that a preset prop recommendation condition is met.

Here, the preset prop recommendation condition includes, for example, a guess accuracy rate of the audience end reaches a set accuracy rate, a rewarding amount of the audience end reaches a set amount, etc.

Step 211: the live streamer end activates the think tank, and the live stream server builds the think tank.

Step 212: the live streamer end starts a game, and the game server starts the game.

Step 213: the audience end participates in recommendation, and sends recommended prop selection information to the live streamer end or connects with the live streamer end by microphone to assist the live streamer end in selecting a virtual prop in the game.

In a specific implementation, the audience end may send the prop selection information recommended by the audience end to a game account of the live streamer end through the live stream server and the game server, or connect with the live streamer end by microphone through the live stream server and the game server, so that the live streamer at the live streamer end can know recommendation of the think tank.

Step 214: the game server sends a result of the game to the live stream server.

Step 215: the live stream server dissolves the think tank and calculates a reward of the think tank in response to determining that the task of the think tank is achieved, sends a message that the think tank is dissolved and the corresponding reward to the corresponding audience end, and sends the message that the think tank is dissolved to the live streamer end.

Step 216: the live streamer end initiates a new recruitment for building a next think tank.

In the following, the method for game live stream interaction in embodiments of the present disclosure will be introduced by taking the live stream of Fight the Landlord as an example.

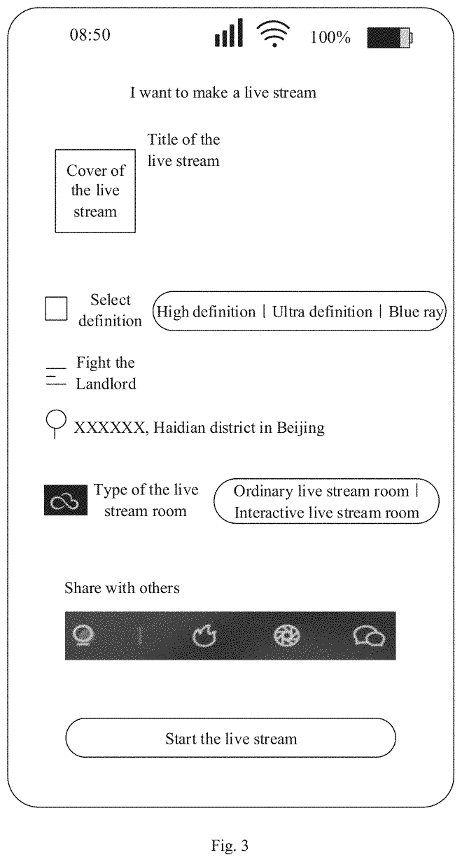

FIG. 3 is a schematic diagram of a page when a live streamer starts a live stream according to an embodiment of the present disclosure. The live streamer at the live streamer end selects a definition, the Fight the Landlord game and a type of the live stream room that be wants, and clicks a start live button to start the live stream of the Fight the Landlord.

There are two types of interactions that the audience can participate in: guess interaction and recommendation interaction. These two interaction modes will be respectively, introduced below.

1. Guess interaction is as follows.

Group-oriented: all users at the audience end who enter the live stream room.

Interaction introduction: after entering the live stream room, the users at the audience end may guess the virtual playing cards that the live streamer will take out; if the guess is correct, the progress of the guess task will be synchronized, and a certain reward will be given when the guess task is completed.

Guess mode: selecting a virtual playing card and clicking to confirm within limited time, and waiting for the live streamer to take out a virtual playing card; if the guessed virtual playing card matches with the virtual playing card taken out by the live streamer, the guess is correct and the reward is obtained, where the matching may be: these two virtual playing cards are exactly the same, or these two virtual playing cards have the same point and different suits. The matching rule may be determined by technicians according to actual needs, and will not be repeated here.

Introduction to the interaction process is as follows.

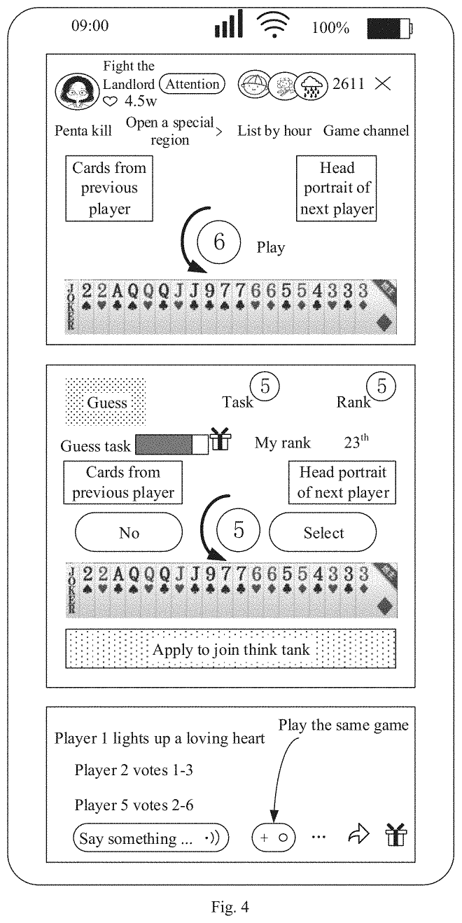

A user at the audience end enters the live stream room and the guess page is displayed by default. FIG. 4 is a schematic diagram of a guess page of Fight the Landlord which is a Chinese poker according to an embodiment of the present disclosure, where the above rectangular box shows the live video resource, i.e., the game perspective of the live streamer end; and the middle rectangular box shows the guess information, i.e., the game perspective of the audience end. In this way, the user at the audience end can see card information of the previous player simultaneously and can select the virtual playing card of the live streamer end autonomously. The rectangular box below shows the gift-giving information and voting information of other audience ends, and the audience end can also perform some interactions such as playing the same, forwarding, and giving gifts in this area.

The guess gameplay will be described below in combination with FIG. 4.

Within the limited time, a card clicked by a user at the audience end is in the selected state. If the button “Select” is clicked, the selected card is highlighted, and the remaining cards are dimmed; if the button “No” is clicked, all cards are dimmed.

If the button “Select” is not clicked within the limited time, then the guess times out and the virtual playing cards disappear, which is deemed that the user dose not participate in this guess.

If the selected card does not conform to the basic rule of Fight the Landlord or cannot win the previous player, “The card you selected does not conform to the rule of Fight the Landlord!” will be prompted.

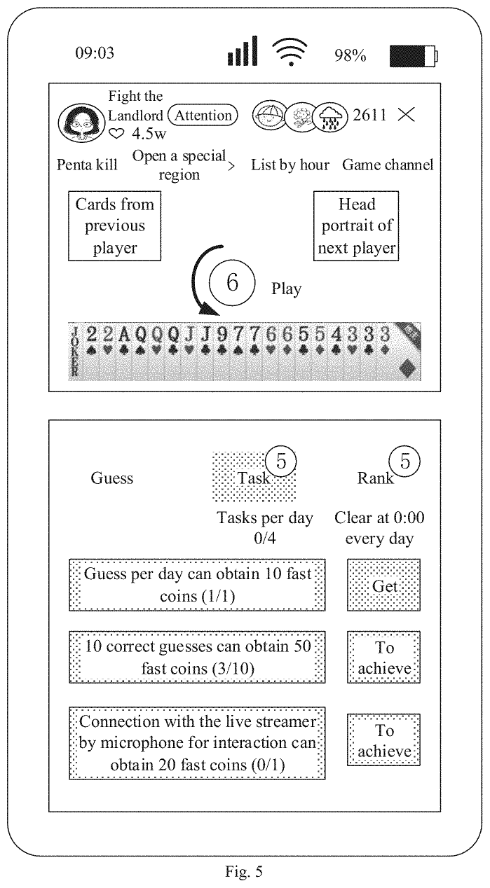

The basic guess task is the number of guesses and displayed on the guess tab. Each time a guess is completed, the task progress bar gives feedback, and the complete task information is on the task tab. FIG. 5 is a schematic diagram of a page of a guess task according to an embodiment of the present disclosure.

After the live streamer at the live streamer end takes out this card; the game server synchronizes the relevant data with the live stream server.

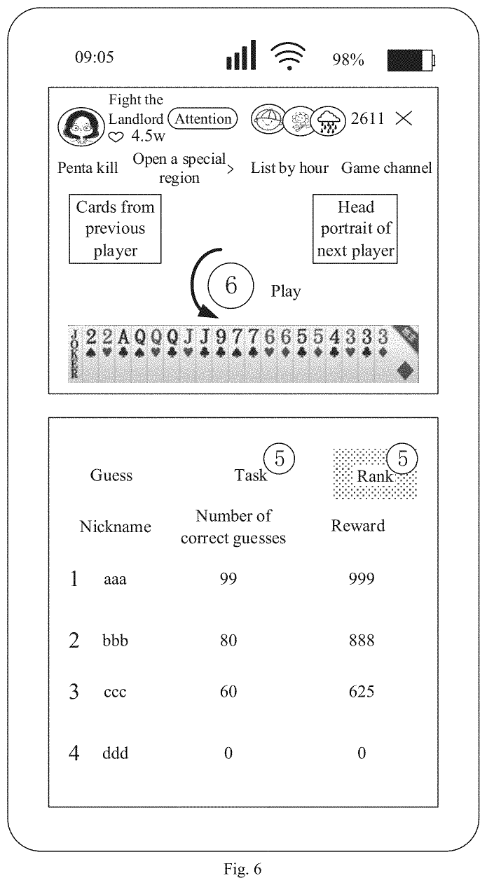

After each deck of cards is settled, the ranking is refreshed once. FIG. 6 is a schematic diagram of a page of guess ranking according to an embodiment of the present disclosure.

2. Recommendation interaction is as follows.

In order not to affect the normal live stream of the live streamer end, the recommendation interaction can be carried out after the live streamer activates the think tank, so the recommendation interaction can also be called as gameplay of think tank.

A user at the audience end participates in guessing in the live stream room. If a certain condition is met, for example, the guess accuracy reaches 70%, the button “Apply to Join the Think Tank” is unlocked and the button “Apply to Join the Think Tank” is clicked to apply to join/queue for the think tank.

After the think tank is full, the live streamer starts the think tank task in the game.

Think tank privileges: ultra-low latency channel such as 300 to 500 ms to enhance the interaction efficiency of the members of the think tank participating in recommendations, the right to access by microphone, recommending hand cards to the game (meaning that the live stream server synchronizes the recommended cards to the game server), additional tasks and rewards.

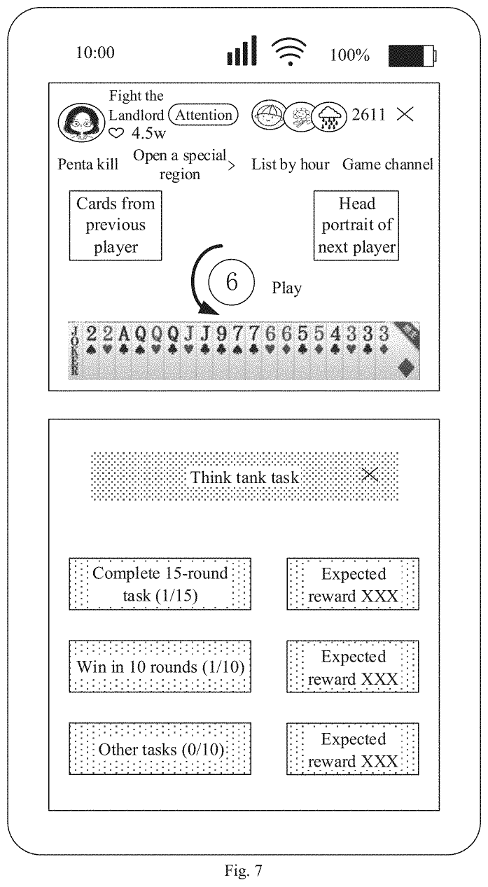

Think tank tasks: task on the number of rounds, task on the number of winning rounds. FIG. 7 is a schematic diagram of a page of a think tank task according to an embodiment of the present disclosure.

Task rewards: rewards of the live stream room, and prop rewards in the game (superior to rewards of the guess task).

Think tank cycle is as follows.

A preset number of rounds are completed, the task of the think tank is reached, the members of the think tank receive rewards, and the old think tank is dissolved.

The users at the audience end in the queue enter a new think tank, and the live streamer starts a new round of think tank task.

Introduction to the interaction process is as follows.

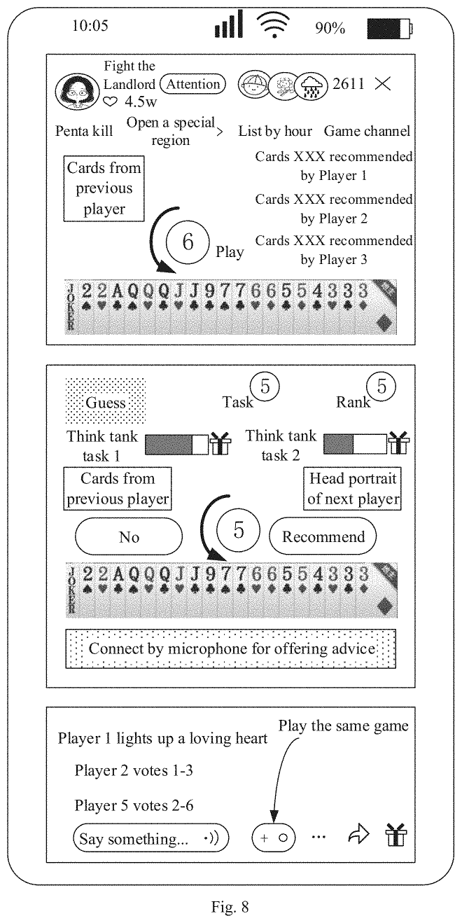

The live streamer clicks on the button “Start Think Tank Task” on the game interface, the game server starts the think tank task and synchronizes the think tank task to the live stream server, and then the live stream server synchronizes to the audience ends corresponding to the members of the think tank. FIG. 8 is a schematic diagram of a recommendation page according to an embodiment of the present disclosure. The gameplay of the think tank will be illustrated below in conjunction with FIG. 8.

A user at the audience end clicks on a hand card, and a selected icon appears. If the button “Recommend” is clicked, the selected card is highlighted, and the remaining cards are dimmed; if the button “No” is clicked, all cards are dimmed. After clicking the button “Recommend”, the recommended hand card information and the user nickname appear in the game interface of the live streamer end.

The live streamer can see the recommended information on the game interface, click any recommended information, and automatically bring up the corresponding card.

After the live streamer takes out the hand card, the progress of the task related to the user at the audience end may change if this card is identical to the recommended card.

The game server or live stream server may summarize users who choose the same card.

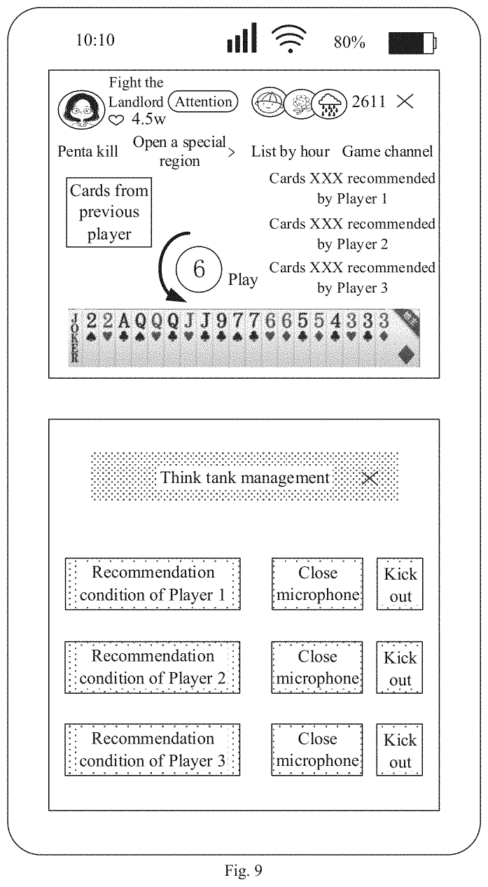

The live streamer may play freely without choosing the recommended card. In addition, the live streamer may also manage a think tank. FIG. 9 is a schematic diagram of a think tank management page according to an embodiment of the present disclosure.

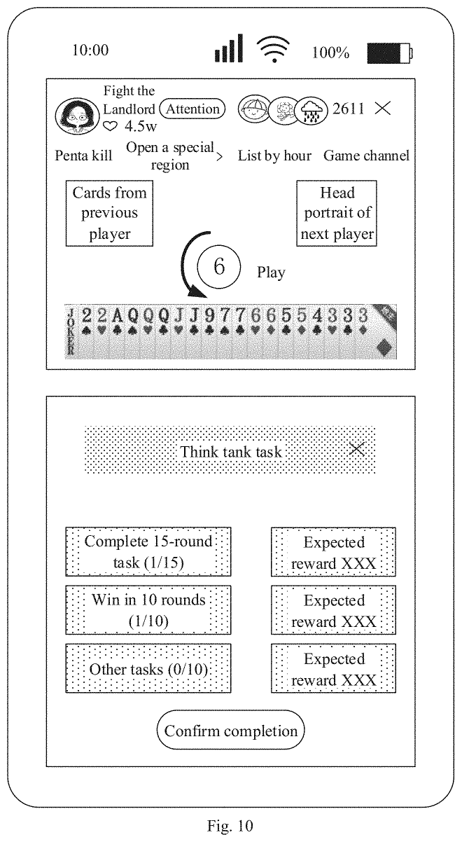

After tasks of the think tank are completed, a task settlement interface pops up. FIG. 10 is a schematic diagram of a settlement page of a think tank task according to an embodiment of the present disclosure.

After clicking “confirm”, the think tank is dissolved, and the users at the audience end in the queue enter a newly formed think tank.

In addition, the audience end may also vote for each way of playing cards. The live stream server synchronizes the voting information to all audience ends in the live stream room, so that the users at the audience end can see the voting information of other users, enhancing the interaction enjoyment.

In an embodiment of the present disclosure, after entering the live stream room, the users at the audience end may “play cards” (guess which card the live streamer will take out later) in the live stream room to win task rewards. The live streamer may start recruiting a think tank in the live stream room and pick out the users at the audience end who satisfy conditions to enter the think tank and have in-depth interaction with the live streamer. The members of the think tank may make suggestions for the live streamer, fight with the live streamer, and have the opportunity to win higher rewards. In this way, all users at the audience end may participate in the game and win task rewards in the live stream room, and the sense of participation and presence of users is improved, so it is easy to retain users.

In addition, all users at the audience end may also vote to decide the card to be taken out by the live streamer next time in the live stream room, that is to say, the decision to take out the card is not made by the live streamer but is made by all audiences, allowing the audiences to be the in-depth participants and decision makers of the game.

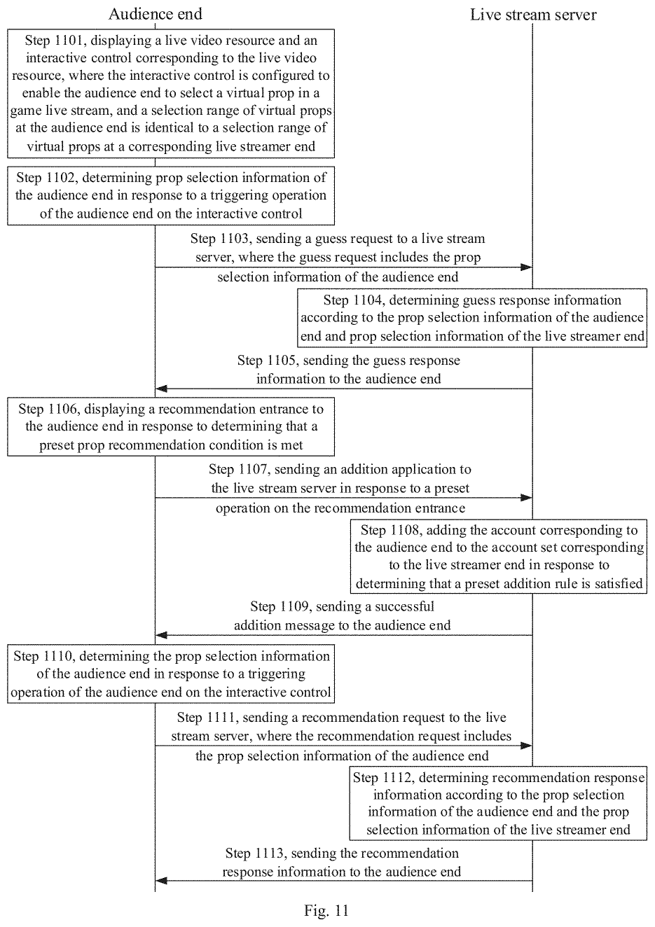

FIG. 11 is a flowchart of a method for game live stream interaction according to an embodiment, and the method includes following steps.

Step 1101: an audience end displays a live video resource and an interactive control corresponding to the live video resource, where the interactive control is configured to enable the audience end to select a virtual prop in a game live stream, and a selection range of virtual props at the audience end is identical to a selection range of virtual props at a corresponding live streamer end.

That is, the props that can be selected by the audience end and the live streamer end in the virtual game are the same.

Step 1102: the audience end determines prop selection information of the audience end in response to a triggering operation of the audience end on the interactive control.

Initially, the user at the audience end may guess the prop used by the live streamer when the live streamer at the live streamer end plays the game.

Step 1103: the audience end sends a guess request to a live stream server, where the guess request includes the prop selection information of the audience end.

Step 1104: the live stream server determines guess response information according to the prop selection information of the audience end and prop selection information of the live streamer end.

That is, in a case that the interaction request is a guess request, the interaction response information is guess response information.

Step 1105: the live stream server sends the guess response information to the audience end.

Step 1106: a recommendation entrance is displayed to the audience end in response to determining that a preset prop recommendation condition is met.

Step 1107: the audience end sends an addition application to the live stream server in response to a preset operation on the recommendation entrance.

Here, the addition application is used to request to add an account corresponding to the audience end to an account set corresponding to the live streamer end, where users corresponding to the account set constitute members of the above think tank.

Step 1108: the live stream server adds the account corresponding to the audience end to the account set corresponding to the live streamer end in response to determining that a preset addition rule is satisfied.

Here, the preset addition rule is that the number of accounts in the account set corresponding to the live streamer end does not reach a specified number.

Step 1109: the live stream server sends a successful addition message to the audience end.

Step 1110: the audience end determines the prop selection information of the audience end in response to a triggering operation of the audience end on the interactive control.

After entering the think tank, the user at the audience end may recommend the prop to be used by the live streamer at the live streamer end when the live streamer plays the game.

Step 1111: the audience end sends a recommendation request to the live stream server, where the recommendation request includes the prop selection information of the audience end.

Step 1112: the live stream server determines recommendation response information according to the prop selection information of the audience end and the prop selection information of the live streamer end.

That is, in a case that the interaction request is a recommendation request, the interaction response information is recommendation response information.

Step 1113: the live stream server sends the recommendation response information to the audience end.

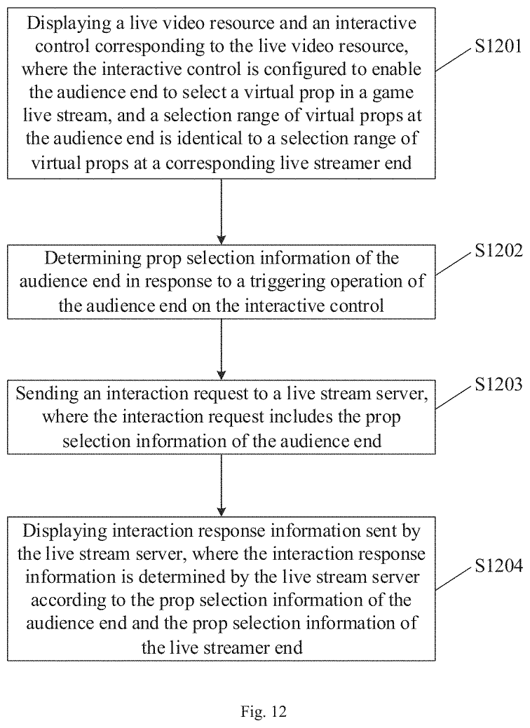

FIG. 12 is a flowchart of another method for game live stream interaction according to an embodiment. This method for game live stream interaction is applied to the audience end, and the flowchart of this method includes following steps.

Step S1201: displaying a live video resource and an interactive control corresponding to the live video resource, where the interactive control is configured to enable the audience end to select a virtual prop in a game live stream, and a selection range of virtual props at the audience end is identical to a selection range of virtual props at a corresponding live streamer end.

Step S1202: determining prop selection information of the audience end in response to a triggering operation of the audience end on the interactive control.

Step S1203: sending an interaction request to a live stream server, where the interaction request includes the prop selection information of the audience end.

In a specific implementation, if an account corresponding to the audience end is not contained in an account set corresponding to the live streamer end, the interaction request is a guess request for guessing prop selection information of the live streamer end; if the account corresponding to the audience end is contained in the account set corresponding to the live streamer end, the interaction request is a recommendation request for recommending the prop selection information to the live streamer end.

In addition, the account corresponding to the audience end may be added to the account set corresponding to the live streamer end according to following steps.

A recommendation entrance is displayed to the audience end (for example, a button for applying to join a think tank is changed to an operable state) when the audience end determines that a preset prop recommendation condition is met, for example, a guess accuracy reaches a preset accuracy; an addition application is sent to the live stream server in response to a preset operation of the audience end on the recommendation entrance, where the addition application is used to request to add the account corresponding to the audience end to the account set corresponding to the live streamer end; and a successful addition message sent by the live stream server is received. Subsequently, the audience end may recommend prop selection information to the live streamer end.

Step S1204: displaying interaction response information sent by the live stream server, where the interaction response information is determined by the live stream server according to the prop selection information of the audience end and the prop selection information of the live streamer end.

Here, the interaction response information includes a task completion status of the audience end and/or an electronic resource obtained.

In some possible embodiments, the audience end may receive the prop selection information of other audience ends sent by the live stream server, and display the prop selection information of other audience ends. In this way, the audience end can know the prop recommendation status of other audience ends, thereby enhancing the interactive enjoyment.

In some possible embodiments, the audience end may also display a voting entrance for the prop selection information of other audience ends. At this time, the audience end may determine the voting result of the audience end in response to the voting operation of the user at the audience end on the voting entrance, and send the voting result of the audience end to the live stream server. That is to say, the audience end may vote for the prop usage of other audience ends. In this way, the sense of participation and presence of the users at the audience end can be further improved, and the interactive effect of the live stream and the game fun can be improved.

In some possible embodiments, the audience end may further receive voting results of other audience ends and/or voting statistics information of various prop selections sent by the live stream server, and display the voting results of other audience ends and/or the voting statistics information of various prop selections. In other words, the audience may learn about the voting results of other audience ends and the voting status of various prop selections. In this way, the sense of participation and presence of the users at the audience end can be further improved, and the interactive effect of the live stream and the game fun can be improved.

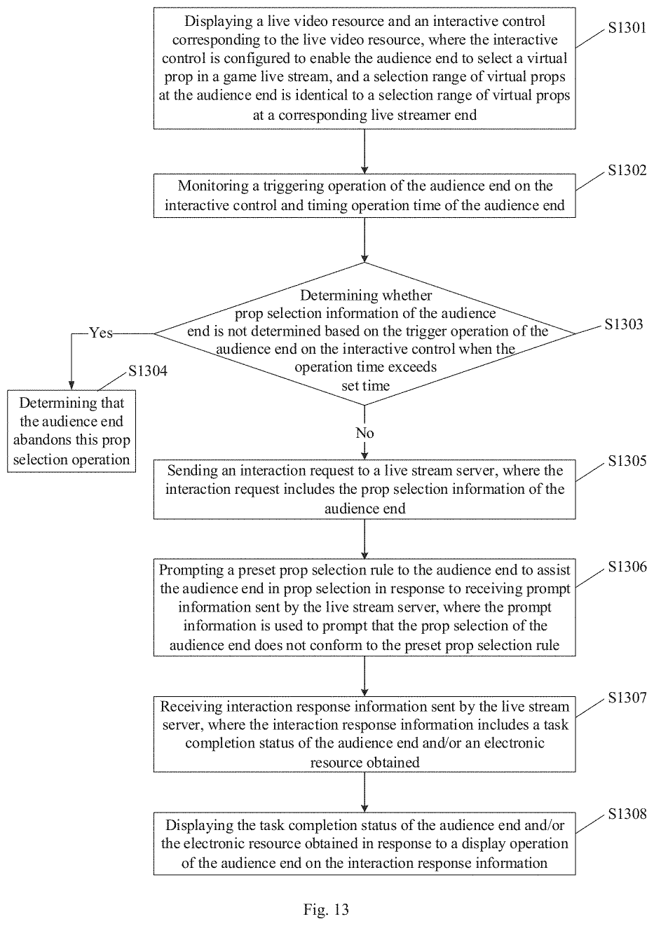

FIG. 13 is a flowchart of another method for game live stream interaction according to an embodiment. This method for game live stream interaction is applied to the audience end, and the flowchart of this method includes following steps.

Step S1301: displaying a live video resource and an interactive control corresponding to the live video resource, where the interactive control is configured to enable the audience end to select a virtual prop in a game live stream, and a selection range of virtual props at the audience end is identical to a selection range of virtual props at a corresponding live streamer end.

Step S1302: monitoring a triggering operation of the audience end on the interactive control and timing operation time of the audience end.

Step S1303: determining whether prop selection information of the audience end is not determined based on the trigger operation of the audience end on the interactive control when the operation time exceeds set time; if the prop selection information of the audience end is not determined, proceed to S1304; if the prop selection information of the audience end is determined, proceed to S1305.

Step S1304: determining that the audience end abandons this prop selection operation.

Step S1305: sending an interaction request to a live stream server, where the interaction request includes the prop selection information of the audience end.

Step S1306: prompting a preset prop selection rule to the audience end to assist the audience end in prop selection in response to receiving prompt information sent by the live stream server, where the prompt information is used to prompt that the prop selection of the audience end does not conform to the preset prop selection rule.

Step S1307: receiving interaction response information sent by the live stream server, where the interaction response information includes a task completion status of the audience end and/or an electronic resource obtained.

Step S1308: displaying the task completion status of the audience end and/or the electronic resource obtained in response to a display operation of the audience end on the interaction response information.

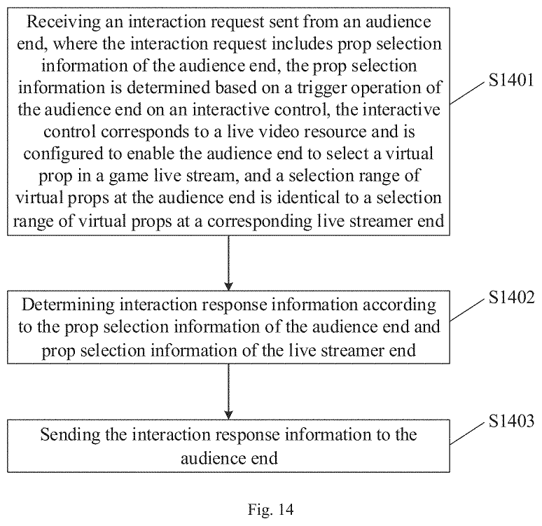

FIG. 14 is a flowchart of another method for game live stream interaction according to an embodiment. This method for game live stream interaction is applied to a live stream server, and the flowchart of this method includes following steps.

Step 1401: receiving an interaction request sent from an audience end, where the interaction request includes prop selection information of the audience end, the prop selection information is determined based on a trigger operation of the audience end on an interactive control, the interactive control corresponds to a live video resource and is configured to enable the audience end to select a virtual prop in a game live stream, and a selection range of virtual props at the audience end is identical to a selection range of virtual props at a corresponding live streamer end.

Here, the interaction request is a guess request for guessing prop selection information of the live streamer end, or a recommendation request for recommending the prop selection information to the live streamer end.

If the audience end wants to send a recommendation request, the audience end may, firstly apply to add an account corresponding to the audience end to an account set corresponding to the live streamer end, so the live stream server may also receive an addition application sent by the audience end, where the addition application is used to request to add the account corresponding to the audience end to the account set corresponding to the live streamer end, if it is determined that a preset addition rule is satisfied, the account corresponding to the audience end may be added to the account set corresponding to the live streamer end, and a successful addition message is sent to the audience end.

In a specific implementation, in a case that the interaction request is a recommendation request, the live stream server may also send the prop selection information of the audience end to the live streamer end to assist the live streamer end in selecting a virtual prop.

For the live streamer end, after receiving the prop selection information of each audience end, the virtual props selected and the virtual props unselected by the audience ends may be displayed differently based on the prop selection information of each audience end, for example, the virtual props selected by the audience ends are highlighted so that the live streamer can clearly know which virtual props are recommended by the audience ends and respond quickly.

Step 1402: determining interaction response information according to the prop selection information of the audience end and prop selection information of the live streamer end.

In a specific implementation, the prop selection information of the audience end may be compared with the prop selection information of the live streamer end to obtain a comparison result which is used to represent whether the prop selection at the audience end matches with the prop selection at the live streamer end, then a task completion status of the audience end is determined according to a preset task corresponding to the interaction request and the comparison result, the electronic resource obtained by the audience end is calculated based on the task completion status of the audience end, and the task completion status of the audience end and/or the electronic resource obtained is/are determined as the interaction response information.

It should be noted that preset tasks corresponding to different interaction requests are different, and the electronic resources that can be obtained by the audience end when completing different preset tasks are also different.

Step 1403: sending the interaction response information to the audience end.

In some possible embodiments, the prop selection information of other audience ends in the live stream room may also be sent to the audience end, so as to further enhance the sense of participation and presence of users at the audience end and retain users.

In some possible embodiments, the audience end may also display a voting entrance for the prop selection information of other audience ends. At this time, the live stream server may also receive the voting result sent by the audience end, where the voting result is obtained by the audience end based on the voting operation for the voting entrance. Then, the corresponding prop selection is voted and counted based on the voting result.

In some possible embodiments, the live stream server may further send the voting results of other audience ends and/or voting statistics information of various prop selections to the audience end for display by the audience end.

In some possible embodiments, prompt information may be sent to the audience end in response to determining that the prop selection of the audience end does not conform to a preset prop selection rule according to the prop selection information of the audience end, where the prompt information is used to prompt that prop selection of the audience end does not conform to the preset prop selection rule.

In a specific implementation, in a case that the live streamer end selects a virtual prop actively, the prop selection information of the live streamer end may be obtained from a game server; in a case that the live streamer end selects a virtual prop passively, various prop selections may be sorted based on the prop selection information currently received, and then the prop selection information of the live streamer end is determined based on a sorting result, for example, the prop selection information corresponding to the most selected prop is used as the prop selection information of the live streamer end. Furthermore, in this case, the live stream server may send the prop selection information of the live streamer end to the game server, and the game server controls the live streamer end to select a virtual prop.

When the method provided in embodiments of the present disclosure is implemented by software or hardware or a combination of software and hardware, the electronic device may include a plurality of functional modules, and each functional module may include software, hardware or a combination thereof.

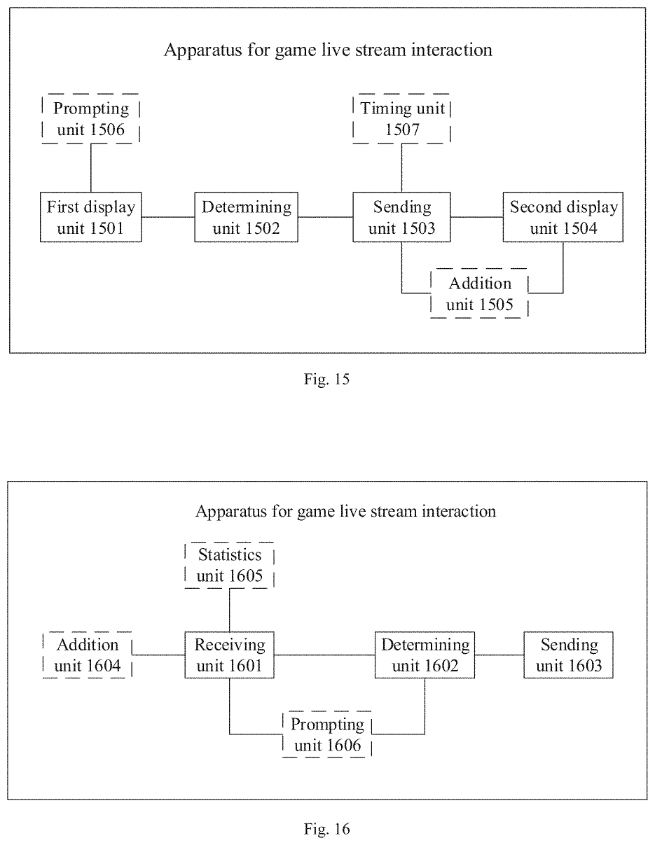

FIG. 15 is a block diagram of an apparatus for game live stream interaction according to an embodiment. This apparatus includes a first display unit 1501, a determining unit 1502, a sending unit 1503 and a second display unit 1504.

The first display unit 1501 is configured to display a live video resource and an interactive control corresponding to the live video resource, where the interactive control is configured to enable an audience end to select a virtual prop in a game live stream, and a selection range of virtual props at the audience end is identical to a selection range of virtual props at a corresponding live streamer end.

The determining unit 1502 is configured to determine prop selection information of the audience end in response to a triggering operation of the audience end on the interactive control.

The sending unit 1503 is configured to send an interaction request to a live stream server, where the interaction request includes the prop selection information of the audience end.

The second display unit 1504 is configured to display interaction response information sent by the live stream server, where the interaction response information is determined by the live stream server according to the prop selection information of the audience end and prop selection information of the live streamer end.

In some possible embodiments, in a case that an account corresponding to the audience end is not contained in an account set corresponding to the live streamer end, the interaction request is a guess request for guessing the prop selection information of the live streamer end.

In some possible embodiments, in a case that an account corresponding to the audience end is contained in an account set corresponding to the live streamer end, the interaction request is a recommendation request for recommending prop selection information to the live streamer end.

In some possible embodiments, the apparatus further includes as addition unit 1505 configured to add the account corresponding to the audience end to the account set corresponding to the live streamer end by: displaying a recommendation entrance to the audience end in response to determining that the audience end meets a preset prop recommendation condition; sending an addition application to the live stream server in response to a preset operation of the audience end on the recommendation entrance, where the addition application is used to request to add the account corresponding to the audience end to the account set corresponding to the live streamer end; displaying a successful addition message sent by the live stream server.

In some possible embodiments, the interaction response information includes a task completion status of the audience end and/or an electronic resource obtained, the second display unit 1504 is further configured to display the task completion status of the audience end and/or the electronic resource obtained in response to a display operation of the audience end on the interaction response information.

In some possible embodiments, the second display unit 1504 is further configured to receive prop selection information of other audience ends in a corresponding live stream room sent by the live stream server.

In some possible embodiments, the second display unit 1504 is further configured to display a voting entrance for the prop selection information of other audience ends; the determining unit 1502 is further configured to determine a voting result of the audience end in response to a voting operation of the audience end on the voting entrance; the sending unit 1503 is further configured to send the voting result of the audience end to the live stream server.

In some possible embodiments, the second display unit 1504 is further configured to display voting results of other audience ends and/or voting statistics information of various prop selections sent by the live stream server.

In some possible embodiments, the apparatus further includes: a prompting unit 1506 configured to prompt a preset prop selection rule to the audience end to assist the audience end in prop selection in response to receiving prompt information sent by the live stream server, where the prompt information is used to prompt that prop selection of the audience end does not conform to the preset prop selection rule.

In some possible embodiments, the apparatus further includes: a timing unit 1507 configured to time prop operation time of the audience end; and determine that the audience end abandons a current prop selection operation in response to determining that the prop selection information of the audience end is not determined when the prop operation time exceeds set time.

FIG. 16 is a block diagram of another apparatus for game live stream interaction according to an embodiment. This apparatus includes a receiving unit 1601, a determining unit 1602 and a sending unit 1603.

The receiving unit 1601 is configured to receive an interaction request sent from an audience end, where the interaction request includes prop selection information of the audience end, the prop selection information is determined based on a trigger operation of the audience end on an interactive control, the interactive control corresponds to a live video resource, the interactive control is configured to enable the audience end to select a virtual prop in a game live stream, and a selection range of virtual props at the audience end is identical to a selection range of virtual props at a corresponding live streamer end.

The determining unit 1602 is configured to determine interaction response information according to the prop selection information of the audience end and prop selection information of the live streamer end.

The sending unit 1603 is configured to send the interaction response information to the audience enol.

In some possible embodiments, the interaction request is a recommendation request for recommending prop selection information to the live streamer end, the sending unit 1603 is further configured to send the prop selection information of the audience end to the live streamer end to assist the live streamer end in selecting a virtual prop.

In some possible embodiments, the apparatus further includes an addition unit 1604, the receiving unit 1601 is further configured to receive an addition application sent by the audience end, where the addition application is used to request to add an account corresponding to the audience end to an account set corresponding to the live streamer end the addition unit 1604 is configured to add the account corresponding to the audience end to the account set corresponding to the live streamer end in response to determining that a preset addition rule is satisfied, and send a successful addition message to the audience end.

In some possible embodiments, the determining unit 1602 is configured to: compare the prop selection information of the audience end with the prop selection information of the live streamer end to obtain a comparison result; determine a task completion status of the audience end according to a preset task corresponding to the interaction request and the comparison result; determine an electronic resource obtained by the audience end based on the task completion status of the audience end; determine the task completion status of the audience end and/or the electronic resource obtained as the interaction response information.

In some possible embodiments, the sending unit 1603 is further configured to send prop selection information of other audience ends in a corresponding live stream room to the audience end for display by the audience ends.

In some possible embodiments, the audience end also displays a voting entrance for the prop selection information of other audience ends, and the apparatus further includes a statistics unit 1605, the receiving unit 1601 is further configured to receive a voting result sent by the audience end, where the voting result is obtained by the audience end performing a voting operation based on the voting entrance; the statistics unit 1605 is configured to perform voting statistics on a corresponding prop selection based on the voting result.

In some possible embodiments, the sending unit 1603 is further configured to send voting results of other audience ends and/or voting statistics information of various prop selections to the audience end for display by the audience end.

In some possible embodiments, the apparatus further includes: a prompting unit 1606 configured to send prompt information to the audience end in response to determining that prop selection of the audience end does not conform to a preset prop selection rule according to the prop selection information of the audience end, where the prompt information is used to prompt that the prop selection of the audience end does not conform to the preset prop selection rule.

In some possible embodiments, the determining unit 1602 is configured to: obtain prop selection information of the live streamer end from a game server in response to determining that the live streamer end selects a virtual prop actively; sort various prop selections based on prop selection information currently received and determine the prop selection information of the live streamer end based on a sorting result in response to determining that the live streamer end selects a virtual prop passively.

Regarding the apparatus in the above embodiments, the specific manner in which each module performs the operations has been described in detail in embodiments related to the method, and will not be illustrated in detail here.

The division of modules in embodiments of the present disclosure is illustrative and is only a logical function division. In actual implementations, there may be other division methods. In addition, the functional modules in various embodiments of the present disclosure may be integrated into one processor or may be exist alone physically, or two or more modules may be integrated into one module. The mutual coupling between various modules may be realized through some interfaces. These interfaces are generally electrical communication interfaces, but it is not excluded that the interfaces may be mechanical interfaces or other forms of interfaces. Therefore, the modules described as separate components may or may not be physically separated, and may be located in one place or distributed to different locations on the same device or different devices. The above-mentioned integrated modules may be implemented in the form of hardware, or may be implemented in the form of software functional modules.

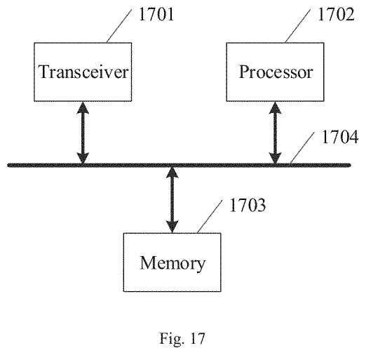

FIG. 17 is a structural schematic diagram of an electronic device for game live stream interaction according to an embodiment. The electronic device includes a transceiver 1701, a processor 1702 and other physical elements, where the processor 1702 may be a Central Processing Unit (CPU), a microprocessor, an application specific integrated circuit, a programmable logic circuit, a large-scale integrated circuit, or a digital processing unit, etc. The transceiver 1701 is configured to receive and send data between the electronic device and other devices.

The electronic device may also include a memory 1703 configured to store software instructions executed by the processor 1702, and of course; the memory may also store some other data required by the electronic device, such as identifier information of the electronic device, encrypted information of the electronic device; user data, etc. The memory 1703 may be a volatile memory, e.g., Random-Access Memory (RAM); or the memory 1703 may be a non-volatile memory, e.g., Read-Only Memory (ROM), flash memory, Hard Disk Drive (HDD) or Solid-State Drive (SSD); or the memory 1703 may be any other medium that can be used to carry or store desired program codes in form of instructions or data structures and can be accessed by computers, but it is not limited thereto. The memory 1703 may be a combination of the above-mentioned memories.

The specific connection medium between the processor 1702, the memory 1703 and the transceiver 1701 is not limited in embodiments of the present disclosure. In an embodiment of the present disclosure, the memory 1703, the processor 1702 and the transceiver 1701 are connected through the bus 1704 as an example for description in FIG. 17. The bus is represented by thick lines in FIG. 17. The connection of other components is only illustrative and is not intended to be a limitation. The bus may be divided into address bus, data bus, control bus, etc. For ease of representation, the bus is represented by only one thick line in FIG. 17, but it does not mean that there is only one bus or one type of bus.

The processor 1702 may be a dedicated hardware or a processor running software. When the processor 1702 can run software, the processor 1702 reads software instructions stored in the memory 1703 and is driven by the software instructions to perform any method for game live stream interaction involved in the above-mentioned embodiments.

An embodiment of the present disclosure further provides a storage medium. When instructions in the storage medium are executed by a processor of an electronic device, the electronic device can perform any method for game live stream interaction involved in the above-mentioned embodiments.

In some possible embodiments, various aspects of the method for game live stream interaction provided in the present disclosure may also be implemented in the form of a program product, which includes program codes. When the program product runs on an electronic device, the program codes are configured to enable the electronic device to perform any method for live stream interaction involved in the above-mentioned embodiments.

After considering the specification and practicing the invention disclosed here, those skilled in the art will readily come up with other embodiments of the disclosure. The disclosure is intended to encompass any variations, usages or applicability changes of the disclosure, and these variations, usages or applicability changes follow the general principle of the disclosure and include the common knowledge or customary technological means in the technical field which are not disclosed in the disclosure. The specification and embodiments are illustrative only, and the true scope and spirit of the disclosure is pointed out by following claims.

It should be understood that the disclosure is not limited to the precise structures which have been described above and shown in the figures, and can be modified and changed without departing from the scope of the disclosure. The scope of the disclosure is only limited by the attached claims.

What is claimed is:

1. A method for game live stream interaction, the method comprising:
displaying a live video resource and an interactive control corresponding to the live video resource, wherein the interactive control is configured to enable an audience end to select a virtual prop in a game live stream, and a selection range of virtual props at the audience end is identical to a selection range of virtual props at a corresponding live streamer end;
determining prop selection information of the audience end in response to a triggering operation of the audience end on the interactive control;
sending an interaction request to a live stream server, wherein the interaction request comprises the prop selection information of the audience end;
displaying interaction response information sent by the live stream server, wherein the interaction response information is determined by the live stream server according to the prop selection information of the audience end and prop selection information of the live streamer end.

2. The method of claim 1, wherein in a case that an account corresponding to the audience end is not contained in an account set corresponding to the live streamer end, the interaction request is a guess request for guessing the prop selection information of the live streamer end.

3. The method of claim 1, wherein in a case that an account corresponding to the audience end is contained in an account set corresponding to the live streamer end, the interaction request is a recommendation request for recommending prop selection information to the live streamer end.

4. The method of claim 3, wherein the account corresponding to the audience end is added to the account set corresponding to the live streamer end by:
displaying a recommendation entrance to the audience end in response to determining that the audience end meets a preset prop recommendation condition;
sending an addition application to the live stream server in response to a preset operation of the audience end on the recommendation entrance, wherein the addition application is used to request to add the account corresponding to the audience end to the account set corresponding to the live streamer end;
displaying a successful addition message sent by the live stream server.

5. The method of claim 1, wherein the interaction response information comprises a task completion status of the audience end and/or an electronic resource obtained, and the method further comprises:
displaying the task completion status of the audience end and/or the electronic resource obtained in response to a display operation of the audience end on the interaction response information.

6. The method of claim 1, wherein the method further comprises:
displaying prop selection information of other audience ends in a corresponding live stream room sent by the live stream server.

7. The method of claim 6, wherein a voting entrance for the prop selection information of other audience ends is also displayed, and the method further comprises:
determining a voting result of the audience end in response to a voting operation of the audience end on the voting entrance;
sending the voting result of the audience end to the live stream server.

8. The method of claim 7, wherein the method further comprises:
displaying voting results of other audience ends and/or voting statistics information of various prop selections sent by the live stream server.

9. The method of claim 1, wherein the method further comprises:
prompting a preset prop selection rule to the audience end to assist the audience end in prop selection in response to receiving prompt information sent by the live stream server, wherein the prompt information is used to prompt that the prop selection of the audience end does not conform to the preset prop selection rule.

10. The method of claim 1, wherein the method further comprises:
timing prop operation time of the audience end;
determining that the audience end abandons a current prop selection operation in response to determining that the prop selection information of the audience end is not determined when the prop operation time exceeds set time.

11. A method for game live stream interaction, the method comprising:
receiving an interaction request sent from an audience end, wherein the interaction request comprises prop selection information of the audience end, the prop selection information is determined based on a trigger operation of the audience end on an interactive control, the interactive control corresponds to a live video resource, the interactive control is configured to enable the audience end to select a virtual prop in a game live stream, and a selection range of virtual props at the audience end is identical to a selection range of virtual props at a corresponding live streamer end;
determining interaction response information according to the prop selection information of the audience end and prop selection information of the live streamer end;
sending the interaction response information to the audience end.

12. The method of claim 11, wherein the interaction request is a recommendation request for recommending prop selection information to the live streamer end, and the method further comprises:
sending the prop selection information of the audience end to the live streamer end to assist the live streamer end in selecting a virtual prop.

13. The method of claim 12, wherein the method further comprises:
receiving an addition application sent by the audience end, wherein the addition application is used to request to add an account corresponding to the audience end to an account set corresponding to the live streamer end;
adding the account corresponding to the audience end to the account set corresponding to the live streamer end in response to determining that a preset addition rule is satisfied, and sending a successful addition message to the audience end.

14. The method of claim 11, wherein determining the interaction response information according to the prop selection information of the audience end and the prop selection information of the live streamer end, comprises:
comparing the prop selection information of the audience end with the prop selection information of the live streamer end to obtain a comparison result;
determining a task completion status of the audience end according to a preset task corresponding to the interaction request and the comparison result;
determining an electronic resource obtained by the audience end based on the task completion status of the audience end;
determining the task completion status of the audience end and/or the electronic resource obtained as the interaction response information.

15. The method of claim 11, wherein the method further comprises:
sending prop selection information of other audience ends in a corresponding live stream room to the audience end for display by the audience end.

16. The method of claim 15, wherein the audience end also displays a voting entrance for the prop selection information of other audience ends, and the method further comprises:
receiving a voting result sent by the audience end, wherein the voting result is obtained by the audience end performing a voting operation based on the voting entrance;
performing voting statistics on a corresponding prop selection based on the voting result.

17. The method of claim 16, wherein the method further comprises:
sending voting results of other audience ends and/or voting statistics information of various prop selections to the audience end for display by the audience end.

18. The method of claim 11, wherein the method further comprises:
sending prompt information to the audience end in response to determining that prop selection of the audience end does not conform to a preset prop selection rule according to the prop selection information of the audience end, wherein the prompt information is used to prompt that the prop selection of the audience end does not conform to the preset prop selection rule.

19. The method of claim 11, wherein in a case that the live streamer end selects a virtual prop actively, the prop selection information of the live streamer end is obtained from a game server;
in a case that the live streamer end selects a virtual prop passively, various prop selections are sorted based on prop selection information currently received, and the prop selection information of the live streamer end is determined based on a sorting result.

20. An electronic device for game live stream interaction, the electronic device comprising:
a processor;
a memory for storing instructions executable by the processor;
wherein the processor is configured to execute the instructions to perform:
displaying a live video resource and an interactive control corresponding to the live video resource, wherein the interactive control is configured to enable an audience end to select a virtual prop in a game live stream, and a selection range of virtual props at the audience end is identical to a selection range of virtual props at a corresponding live streamer end;
determining prop selection information of the audience end in response to a triggering operation of the audience end on the interactive control;
sending an interaction request to a live stream server, wherein the interaction request comprises the prop selection information of the audience end;
displaying interaction response information sent by the live stream server, wherein the interaction response information is determined by the live stream server according to the prop selection information of the audience end and prop selection information of the live streamer end.
